(19) United States
(12) Patent Application Publication
(10) Pub. No.: US 2010/0013432 A1
(43) Pub. Date: Jan. 21, 2010

(54) BATTERY CHARGER

(76) Inventors: Shoichi TOYA, Minamiawaji City (JP); Tatehito Yagi, Sumoto City (JP); Takahiro Yamashita, Sumoto City (JP); Toshiki Nakasho, Sumoto City (JP); Mamoru Yoshida, Minamiawaji City (JP)

Correspondence Address: WENDEROTH, LIND & PONACK, L.L.P., 1030 15th Street, N.W.,, Suite 400 East, Washington, DC, 20005-1503, US

(21) Appl. No.: 12/504,025

(22) Filed: Jul. 16, 2009

(30) Foreign Application Priority Data
Jul. 17, 2008 (JP) 2008-186571

(51) Int. Cl. H02J 7/02

(52) U.S. Cl. 320/108; 320/148; 320/137

(57) ABSTRACT

A battery charger 100 that charges a battery 40 is provided with a power supply circuit 12 to supply power to charge the battery, a control section 13 to control the power supply circuit 12, and an output terminal 19 connected to the input-side of the power supply circuit 12 via an input switch 18. When the battery 40 becomes fully-charged, the control section 13 controls the power supply circuit 12 OFF and the input switch ON to output the input power from the output terminal 19.

### BACKGROUND OF THE INVENTION

1. Field of the Invention

The present invention relates to a battery charger.

2. Description of the Related Art

In Japanese Laid-Open Patent Publication No. JP2000-253595 A, a battery charger is provided with a plurality of charging contacts to allow charging of a plurality of attached battery units.

Further, this prior art battery charger provides a plurality of switches to sequentially supply power from a single charging circuit to a plurality of charging contacts to enable battery charging.

### SUMMARY OF THE INVENTION

In the battery charger of the prior art disclosure above, four battery units, representing a plurality of battery units, can be charged, and correspondingly, four sets of charging contacts and switches are provided. For charging in the case where the user has only two battery units, only two sets of contacts and two switches are required, and the other contacts and switches are unnecessary. Purchase of a battery charger provided with unnecessary charging structures and functions is wasteful. If the user has five battery units for charging, it is necessary to purchase two of the battery chargers described in the prior art disclosure above. As mentioned, this is equivalent to purchasing a battery charger provided with unnecessary charging structures and functions, and is wasteful.

The present invention was developed with the object of resolving this type of drawback. Thus, it is a primary object of the present invention to provide a battery charger that can charge a plurality of batteries corresponding to the needs of the user without providing unnecessary battery charger functions and structures.

In the battery charger of the present invention, the battery charger 100, which charges a battery 40, is provided with a power supply circuit 12 to supply charging power, a control section 13 to control the power supply circuit 12, and an output terminal 19 connected to the input-side of the power supply circuit 12 by an input switch 18. This battery charger has the characteristic that when the battery 40 become fully-charged, the control section 13 turns the power supply circuit 12 OFF and the input switch 18 ON to redirect input power out the output terminal 19.

In the battery charger of the present invention, a plurality of battery chargers is used with the output terminal of one battery charger connected to the other battery chargers to allow the battery in the other battery chargers to be charged after the battery in the first battery charger reach full-charge. Since a plurality of batteries can be sequentially charged with only the number of battery chargers required by the user, there are no unnecessary functions and structures in contrast to the prior art described above.

The above and further objects of the present invention as well as the features thereof will become more apparent from the following detailed description to be made in conjunction with the accompanying drawings.

### BRIEF DESCRIPTION OF THE DRAWINGS

FIG. 1 is a block diagram of a charging stand and battery device for one embodiment of the present invention;

FIG. 2 is a timing diagram showing the relation between power supplied to the charging circuit from the receiving coil and current in the transmitting coil;

FIG. 3 is a block diagram showing a plurality of charging stands connected to a single alternating current (AC) adapter;

FIG. 4 is a timing diagram showing data transmission by ON-OFF switching of a battery device control circuit switching device;

FIG. 5 is an oblique view of a hand-held battery device and charging stand for an embodiment of the present invention;

FIG. 6 is cross-section view at the line A-A through the hand-held battery device and charging stand shown in FIG. 5;

FIG. 7 is an oblique view of the charging stand;

FIG. 8 is an oblique view of the charging stand shown in FIG. 7 with the upper casing removed;

FIG. 9 is a backside oblique view as viewed from below of a plurality of charging stands used in a side-by-side arrangement;

FIG. 10 is an exploded oblique view showing battery pack removal from the hand-held battery device;

FIG. 11 is a bottom oblique view of the battery pack shown in FIG. 10;

FIG. 12 is an exploded oblique view of the battery pack shown in FIG. 11;

FIG. 13 is an oblique view showing another embodiment of the battery pack; and

FIG. 14 is an oblique view showing the output terminals of the battery pack shown in FIG. 13.

### DETAILED DESCRIPTION OF THE EMBODIMENT(S)

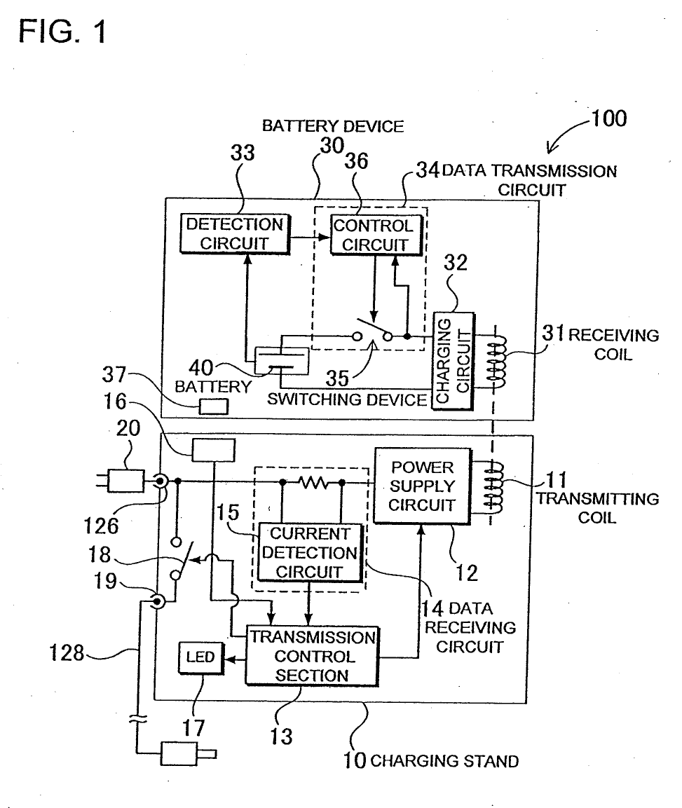

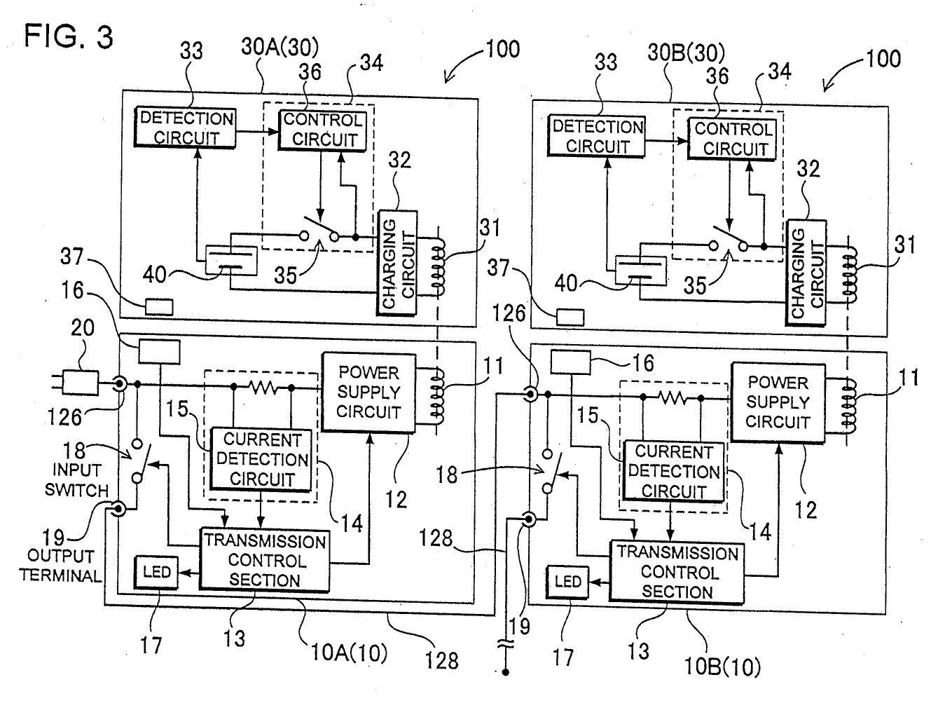

FIG. 1 is a block diagram showing a battery device 30 housing a rechargeable battery 40 as its power source, and a charging stand 10 that charges the battery 40 housed in a battery device 30 set on the stand. Any battery that can be recharged, such as nickel hydride battery, nickel cadmium battery, or lithium ion battery can be used as the battery 40 housed in the battery device 30. Further, FIG. 3 shows connection of two charging stands 10 to one AC adapter 20. In the block diagrams of FIGS. 1 and 3, a battery charger 100, which charges the battery 40, is configured with a power supply circuit 12 that supplies charging power, and a transmission control section 13 as the control circuit 13 to control the power supply circuit 12. The battery charger 100 is made up of the charging stand 10 and the battery device 30.

The battery device 30 is provided with a receiving coil 31 magnetically coupled with the transmitting coil 11 of the charging stand 10; a charging circuit 32 that converts (alternating current) AC power induced in the receiving coil 31 to (direct current) DC for charging the battery 40; a detection circuit 33 that monitors the condition of the battery 40 being charged such as battery voltage, current, temperature, and full-charge; and a data transmission circuit 34 that controls the switching device 35 to switch the receiving coil 31 load and send data detected by the detection circuit 33.

Although not illustrated, the charging circuit 32 is provided with a rectifying circuit to convert AC power induced in the receiving coil 31 to DC, and a capacitor smoothing circuit to smooth ripple current in the DC of the rectifying circuit. Charging circuit 32 design is optimized for the type of battery 40 to be charged. For example, a charging circuit for a nickel hydride battery or nickel cadmium battery is provided with a constant current circuit to deliver stabilized output current. A charging circuit for a lithium ion battery contains constant voltage-constant current charging circuits.

The detection circuit 33 detects battery 40 voltage, current, temperature, and full-charge. A circuit to detect battery current detects the voltage generated across a current detection resistor (not illustrated) connected in series with the battery by amplifying that voltage with an amplifier (not illustrated). Charging current is determined from the amplifier output voltage. A circuit to detect battery temperature is connected with a temperature sensor (not illustrated) that is disposed in close thermal contact with the battery. The temperature sensor is a device such as a thermistor that changes electrical resistance with temperature, and battery temperature is determined by detecting the resistance of the sensor. A detection circuit for a battery device housing a nickel hydride battery or nickel cadmium battery detects the peak voltage of the battery being charged or a AV drop from the peak voltage to determine full-charge. In a battery device housing a lithium ion battery, full-charge can be determined by detecting battery voltage, or during constant voltage charging after constant current charging full-charge can be determined when charging current drops below a set value.

The data transmission circuit 34 is provided with a switching device 35 connected to the receiving coil 31 via the charging circuit 32, and a control circuit 36 that controls the switching device 35 ON and OFF. The control circuit 36 can be circuitry such as a micro-controller that uses power from the receiving coil 31 as its power source. The battery device 30 shown in FIG. 1 has the switching device 35 connected in series with the battery 40. A switching device used to control battery 40 charging ON and OFF can serve the dual purpose as switching device 35 for data transmission. The switching device 35 is controlled OFF to open-circuit the load on the receiving coil 31 through the charging circuit 32. However, although not illustrated, the switching device can also connect directly in series with the receiving coil without intervention of the charging circuit. This type of switching device is also controlled OFF to directly open-circuit the load on the receiving coil. Based on data such as battery information gathered by the detection circuit 33, the control circuit 36 controls the switching device 35 in patterns corresponding to the data to change the load on the receiving coil 31. As noted, AC power induced in the receiving coil 31 is input to the charging circuit 32 and converted to DC by the charging circuit 32 to charge the battery 40. When the battery 40 is being charged by the receiving coil 31, the control circuit 36 controls the switching device 35 to the ON state. A switching device 35 in the ON state supplies charging circuit 32 output to the battery 40 to charge the battery 40. When charging is stopped or battery data are sent to the charging stand 10 on the transmitting coil 11 side, the control circuit 36 switches the switching device 35 OFF.

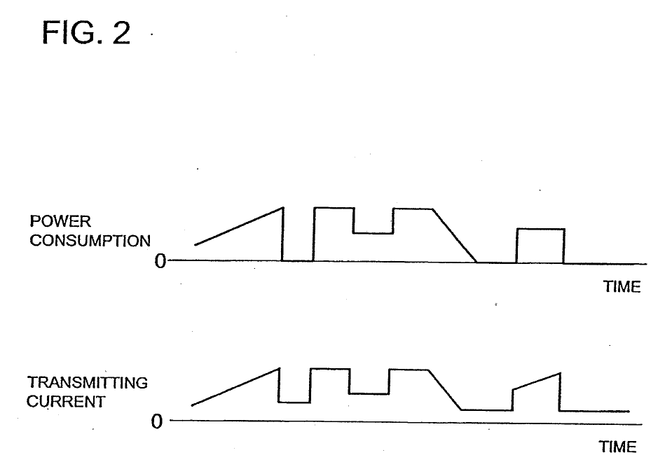

When the switching device 35 is switched from ON to OFF to open-circuit the load on the receiving coil 31, current is changed in the transmitting coil 11, which is magnetically coupled with the receiving coil 31. FIG. 2 shows current in the transmitting coil 11 corresponding to power supplied to the charging circuit 32 from the receiving coil 31.

As shown in this figure, when the switching device 35 is switched OFF to open-circuit the load on the receiving coil 31 and reduce the power supplied to the charging circuit 32 to zero, current in the transmitting coil 11 also decreases. Consequently, the charging stand 10 on the transmitting coil 11 side can detect current in the transmitting coil 11 to determine that the switching device 35 on the receiving coil 31 side was switched from ON to OFF.

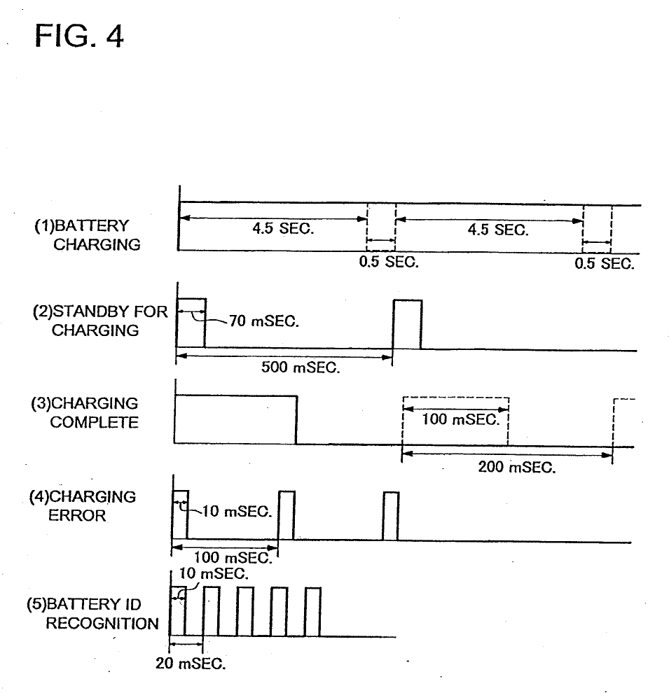

FIG. 4 shows battery data transmission by switching the switching device 35 ON and OFF with the control circuit 36 of the battery device 30 shown in FIG. 1. This figure shows prescribed pulse patterns of receiving coil 31 current resulting from the control circuit 36 switching the switching device 35 ON and OFF. In this figure, the horizontal axis is time, and the vertical axis indicates the receiving-side power (battery charging power). The receiving-side power wave-form, the transmitting-side current wave-form, and the controlled pattern of the switching device 35 are all of a similar pattern, and that pattern also indicates the change in load on the receiving coil 31.

FIG. 4 (1) indicates battery 40 charging, which is shown here as data. In this state, the control circuit 36 keeps the switching device 35 continuously ON. However, as shown by the broken lines in the figure, the switching device 35 can also be pulsed OFF briefly (for example, 4.5 sec. of charging ON and 0.5 sec. of charging OFF). In this state, power is transmitted from the transmitting coil 11 to the receiving coil 31, and output from the receiving coil 31 is supplied to the charging circuit 32 to charge the battery 40. In the charging stand 10 on the transmitting coil 11 side, this charging state is detected and displayed by lighting the pilot lamp, which is a light emitting diode (LED) 17.

FIG. 4 (2) indicates the standby state waiting for charging. In this state, the control circuit 36 keeps the switching device 35 OFF while briefly pulsing ON to transmit the standby for charging condition to the charging stand 10 on the transmitting coil 11 side. (Here, the pulse period can be set, for example, to approximately 500 msec. with a pulse width of approximately 70 msec.) The charging stand 10 detects the standby state and establishes conditions to transmit power from the transmitting coil 11 to the receiving coil 31 to enable battery 40 charging. Since the battery 40 in the standby condition is in a chargeable state, the LED 17 pilot lamp is lighted. This type of standby state occurs, for example, when battery temperature is outside a specified range (for example 0-40° C.) at the start of charging.

FIG. 4 (3) indicates the battery 40 is fully charged, and here the control circuit 36 switches the switching device 35 OFF. However, as shown by the broken lines of the figure, the control circuit 36 can also periodically switch the switching device 35 ON to transmit the fully charged state to the charging stand 10 on the transmitting coil 11 side. (The pulse period can be set, for example, to approximately 200 msec. with a pulse width of approximately 100 msec.) The transmitting coil 11 side detects that the switching device 35 is held continuously OFF for a specified period, and stops transmitting power from the transmitting coil 11 to the receiving coil 31. Specifically, supply of AC power to the transmitting coil 11 is stopped. In this state, the charging stand 10 on the transmitting coil 11 side turns the LED 17 OFF to indicate charging has stopped.

FIG. 4 (4) indicates detection of a charging error that does not allow normal battery 40 charging. The control circuit 36 switches the switching device 35 ON with a prescribed period, for example 100 msec., and a prescribed pulse width, for example 10 msec., to transmit the charging error to the charging stand 10. The charging stand 10 detects the charging error and stops transmitting power from the transmitting coil 11 to the receiving coil 31. Specifically, supply of AC power to the transmitting coil 11 is stopped. In this state, the LED 17 pilot lamp blinks ON and OFF to indicate a charging error.

In FIG. 4 (5), the control circuit 36 switches the switching device 35 ON and OFF in a specific pattern (for example, periodic pulses with approximately 20 msec. period and approximately 10 msec. pulse width) to transmit battery identification (ID) information as battery data to the charging stand 10. The charging stand 10 detects the transmitted ID, confirms the battery ID is proper, and then begins charging. Specifically, the charging stand 10 initially transmits power from the transmitting coil 11 to the receiving coil 31. The charging stand 10 detects the battery ID and begins transmitting power from the transmitting coil 11 to the receiving coil 31 when the ID is determined to be proper, but when the ID is determined to be improper, transmission of power from the transmitting coil 11 to the receiving coil 31 is not started. Specifically, supply of AC power to the transmitting coil 11 is not started. Here, the charging stand 10 first begins transmitting power when it determines the battery device 30 has been set on the charging stand 10. Next, the battery device 30 control circuit 36 begins operating with power transmitted from the charging stand 10 allowing the battery ID data to be transmitted. Within a predetermined time period after beginning power transmission, the charging stand 10 determines if ID data has been sent from the battery device 30. If the battery ID information cannot be recognized, power transmission is stopped.

The patterns shown in FIG. 4 (2)-(5) are set with periods in the range of 200 msec. to 1000 msec. and with pulse widths in the range of 5 msec. to 200 msec. to allow distinction of various battery data for each battery. Although these patterns can be recognized in one pulse period, several pulse periods are repeated (2-10 periods, preferably 3-6 periods, and more preferably 4 periods) for reliable detection at the charging stand 10 side. Here, the battery 40 is charged when current, voltage, and power are applied to the battery 40 according to the pattern for data transmission. Therefore, since the battery is charged for the purpose of data transmission, the number of pulse periods should be set giving consideration to reliable detection at the charging stand 10 side as well as to any detrimental effect on the battery (such as over-charging).

For the case of pulse patterns with identical single periods, distinction can also be made, for example, between data for an individual battery by establishing a different number of pulse periods for each battery.

The charging stand 10 is provided with a power supply circuit 12 that converts input power to AC with a prescribed frequency and supplies it to the transmitting coil 11, a transmission control section 13 that controls the power supply circuit 12 and the supply of power to the transmitting coil 11, and a data receiving circuit 14 that detects battery data from the change in transmitting coil 11 current and outputs that data to the transmission control section 13.

The power supply circuit 12 supplies charging power, and is a DC-to-AC inverter that converts DC input from the AC adapter to AC (or a train of pulses) with a prescribed frequency and voltage. In this power supply circuit 12, a power transistor (not illustrated) connected to the primary-side of a transformer (not illustrated) is switched ON and OFF with a prescribed period to convert DC to AC for output. By holding the power transistor of this power supply circuit 12 OFF, AC output to the transmitting coil 11 can be cut-off.

The data receiving circuit 14 detects current supplied to the power supply circuit 12 (current flowing through the transmitting coil 11) to determine receiving coil 31 load variation, that is switching device 35 ON-OFF switching. The data receiving circuit 14 shown in figures is a current detection circuit 15 that detects current supplied to the power supply circuit 12. As shown in FIG. 2, when the switching device 35 is switched OFF, current through the transmitting coil 11 decreases and power consumed by the power supply circuit 12 decreases. As a result, the decrease in current supplied to the power supply circuit 12 can be detected to detect ON-OFF switching of the switching device 35. However, although not illustrated, the data receiving circuit can also be a current detection circuit that directly measures current flowing through the transmitting coil. Since transmitting coil 11 current decreases when the switching device 35 is switched OFF as shown in FIG. 2, the decrease in current supplied to the power supply circuit 12 can be detected to determine that the switching device 35 was switched OFF. The battery device 30 on the receiving coil 31 side detects the state of the battery 40 and switches the switching device 35 OFF to transmit battery data. Therefore, the data receiving circuit 14 can detect and output battery data from current variation detected by the current detection circuit 15. For example, the current detection circuit 15 can detect the patterns of current variation shown in FIG. 4 (1)-(5) to detect and output receiving coil 31 data that are (1) charging, (2) standby for charging, (3) battery full-charge, (4) charging error, and (5) battery ID data.

As the control section, the transmission control section 13, which can be inside a micro-controller for example, controls the power supply circuit 12 according to individual battery data input from the current detection circuit 15, which is the data receiving circuit 14. Specifically, for the case of FIG. 4 (1) charging and (2) standby for charging, AC power is supplied from the power supply circuit 12 to the transmitting coil 11 to transmit power from the transmitting coil 11 to the receiving coil 31. In the case where FIG. 4 (3) battery 40 full-charge and (4) charging error are detected, the transmission control section 13 controls the power supply circuit 12 to stop its output. The DC-to-AC inverter of the power supply circuit 12 can hold the power transistor, which can be a semiconductor switching device connected to the primary-side of the transformer, in the OFF state to cut-off AC output to the transmitting coil 11. In addition, if data indicating a proper battery ID are input to the transmission control section 13 from the current detection circuit 15, supply of AC power to the transmitting coil 11 is started. If data indicating an improper battery ID are input to the transmission control section 13, supply of AC power to the transmitting coil 11 is stopped. If input from the current detection circuit 15, which is the data receiving circuit 14, has a period, such as 5 msec. (which is shorter than the shortest pulse width shown in FIG. 4), it can be taken as battery data. This type of data can be detected, arithmetically operated on, recognized, and judged as battery information. The transmission control section 13 recognizes and judges this type of battery data, and then controls the power supply circuit 12 according to the data.

The transmission control section 13 controls the power supply circuit 12 according to battery data input from the current detection circuit 15, which is the data receiving circuit 14. In the battery device 30, battery 40 parameters such as voltage, current, and temperature are detected by the detection circuit 33. The control circuit 36 switches the switching device 35 ON and OFF according to the detected signals to transmit battery data to the charging stand 10. Consequently, the charging stand 10 current detection circuit 15 detects battery data sent from the battery device 30 indicating battery 40 parameters such as voltage, current, and temperature; and the transmission control section 13 can control the power supply circuit 12 in accordance with the detected battery data. For example, if battery 40 voltage, current, or temperature is in an abnormal range, power supply circuit 12 output can be cut-off to stop power transmission from the transmitting coil 11 to the receiving coil 31.

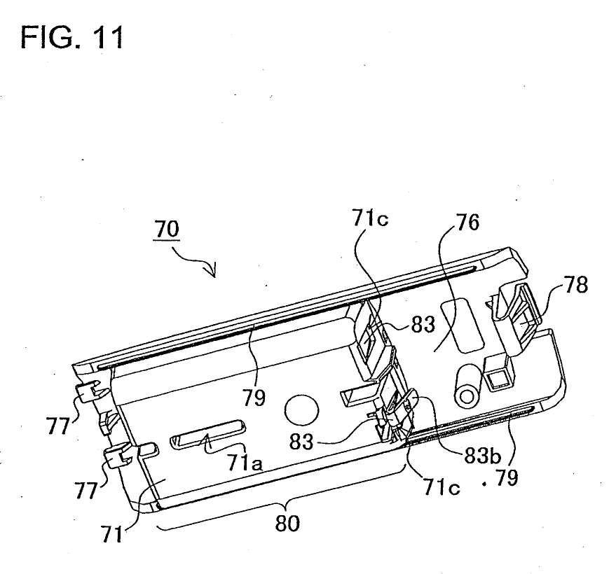

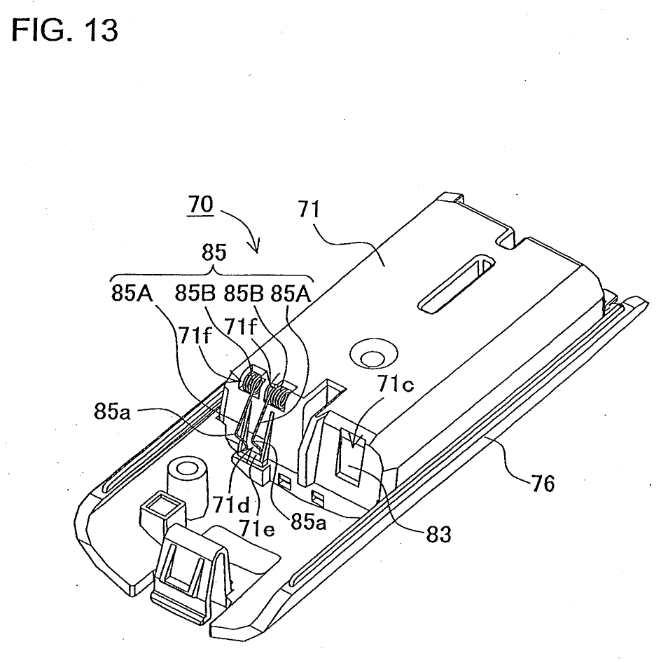

The charging stand 10 detects proper placement of the battery device 30 on the charging stand 10 as follows. The battery device 30 shown in FIGS. 1 and 3 houses a magnet 37 (in an interior storage cavity of the rear cover 76 shown in FIGS. 11 and 13 described later), and the charging stand 10 houses a Hall-effect integrated circuit (IC) 16 positioned opposite the battery device 30 magnet 37 when the battery device 30 is set in the prescribed position on the charging stand 10. (In FIG. 8, which is described later, the Hall-effect IC 16 is disposed on a slanted support platform 16′ positioned opposite the battery device 30 magnet 37 when the battery device 30 is set on the charging stand 10.) In the charging stand 10, when the Hall-effect IC 16 detects the battery device 30 is set in the prescribed position, the Hall-effect IC 16, which utilizes the Hall-effect, issues an ON signal to the transmission control section 13. When an ON signal is input to the transmission control section 13, the power supply circuit 12 is controlled for transmission of power from the transmitting coil 11 to the receiving coil 31. Specifically, the charging stand 10 is put in the output ON state. In the battery device 30, the control circuit 36 is activated by power sent from the charging stand 10 putting it in a state capable of transmitting the battery 40 ID. Subsequently, the battery device 30, which is being supplied with power, transmits battery ID data. After starting power transmission, the charging stand 10 monitors transmissions from the battery device 30 over a fixed time interval for the battery ID data. If no battery ID data can be recognized power transmission is stopped.

FIG. 3 shows connection of two charging stands 10 to one AC adapter 20. When the battery 40 set in a first charging stand 10A becomes fully charged, the AC adapter 20 is switched to a second charging stand 10B to sequentially supply power to two charging stands 10 with one AC adapter 20. This sequentially charges the battery 40 housed in the battery device 30 set in each charging stand 10. The first charging stand 10A is provided with an input switch 18 on the input-side of the power supply circuit 12 to control power supplied to the second charging stand 10B, and an output terminal 19 to output power from the input switch 18. The input switch 18 is controlled by the transmission control section 13. When the battery 40 contained in the first battery device 30A set on the first charging stand 10A reaches full-charge, the transmission control section 13 switches the power supply circuit 12 OFF, then switches the input switch 18 ON to supply power from the AC adapter 20 to the second charging stand 10B connected to the output terminal 19. The second charging stand 10B charges the battery 40 in the second battery device 30B set in the second charging stand 10B with power input from the AC adapter 20. By connecting a plurality of the charging stands 10 shown in FIG. 3, power can be supplied sequentially to a plurality of charging stands using a single AC adapter 20. In the present embodiment, the battery 40 is charged by supplying power from the power supply circuit 12 via a non-contact charging method with a transmitting coil 11 and a receiving coil 31. However, it is also possible to obtain DC power from a power supply circuit, supply it to the battery, and detect battery full-charge according to well-known practice. In this case, as a conventional battery charger, the battery and the battery charger use contacts, such as metal contact terminals, to charge the battery via contacts.

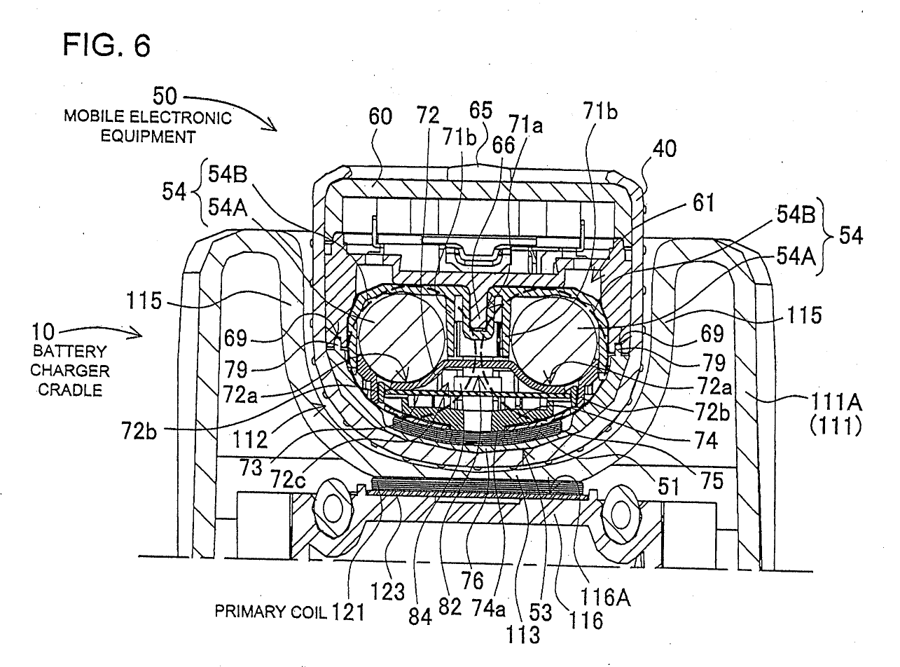

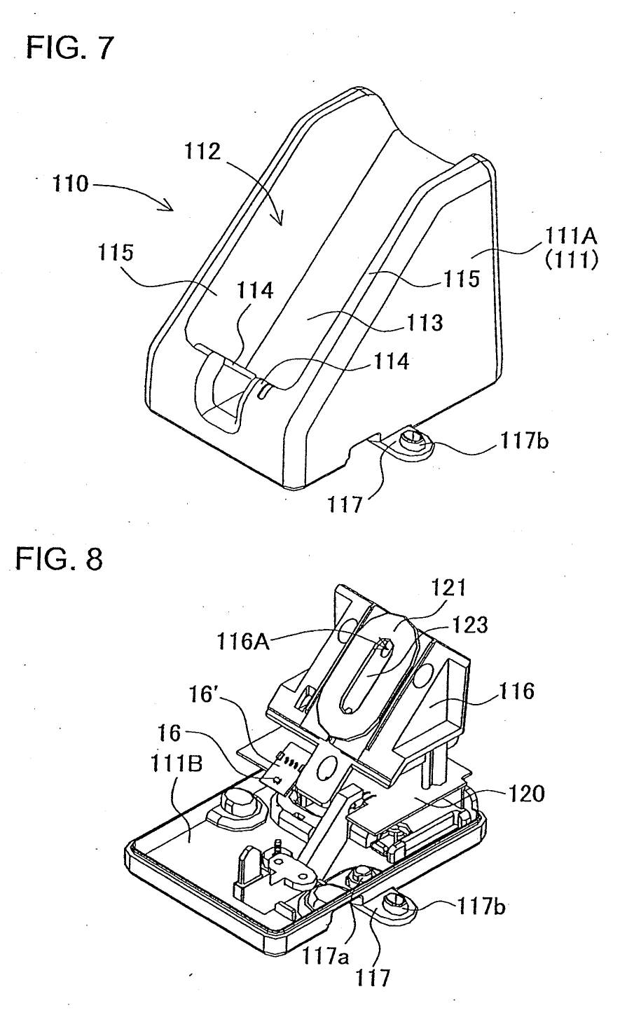

FIGS. 7 and 8 show a hand-held electronic device as the battery device 50 (corresponding to the battery device 30 in the block diagrams of FIGS. 1 and 3) placed on a mounting section 112 of a charging stand 10. As shown in FIG. 6, the battery device 50 houses a receiving coil 51, and batteries 54 that are charged by power transmitted to the receiving coil 51. The battery device 50 is set on the mounting section 112 of the casing 111 of the charging stand 10 in a detachable fashion to charge the batteries 54 in the battery device 50. In the present embodiment, a remote control for an electronic product such as a video game can be used as the battery device 50, which is a battery driven device.

The charging stand 10 of FIGS. 6 and 7 has the mounting section 112 established on an upper casing 111A. The bottom surface of the mounting section 112 of the upper casing 111A is a curved bottom surface 113, which is curved as a U-shaped groove. In the mounting section 112 of the upper casing 111A, the lengthwise direction of the U-shaped curved bottom surface 113 slopes upward toward the rear and the bottom end is provided with a stopper wall 114. A cross section perpendicular to the lengthwise direction of the mounting section 112 is a U-shaped groove that serves to guide the battery device 50 to a precise position. The upper casing 11A is fabricated of a plastic material and is provided with a pair of side walls 15 on either side of the mounting section 112, and a stopper wall 114 at the bottom end of the mounting section 112. As shown in FIGS. 6 and 8, the charging stand 10 has a transmitting coil 121 disposed inside the curved bottom surface 113 of the upper casing 111A. The transmitting coil 121 is a flat coil wound in a planar fashion and is disposed in close proximity to the inside of the curved bottom surface 113. The transmitting coil 121 is wound in a flat loop elongated in the lengthwise direction of the U-shaped groove to enable power transmission over a wide area in the lengthwise direction. The transmitting coil 121 of the figures is a planar coil, but the transmitting coil can also be a flat coil curved to conform to the curved bottom surface. Here, the transmitting coil 11 and receiving coil 31 shown in the block diagrams of FIGS. 1 and 3 are labeled as the transmitting coil 121 and receiving coil 51 in FIGS. 6, 8, and 12. The transmitting coil 121 has a shield layer 123 provided on the side opposite the receiving coil 51, which is under the transmitting coil 121 in the figures. The shield layer 123 is a metal or ferrite layer having a high magnetic permeability to shield the side of the transmitting coil 121 opposite to the receiving coil 51. The shield layer 123 and transmitting coil 121 are attached to a plastic support platform 116 housed in the casing 111. The support platform 116 is attached to the lower casing 111B in a manner that sandwiches the circuit board 120 and disposes the transmitting coil 121 and shield layer 123 in fixed positions in the casing 111. The support platform 116 has a slanted surface 116A that follows the curved bottom surface 113, and the shield layer 123 and the transmitting coil 121 are stacked in layers on the slanted surface 116A. Further, a slanted support platform 16′ is disposed on the circuit board 120 in a position opposite the battery device 30 magnet 37 when the battery device 30 is set on the charging stand 10, and the Hall-effect IC 16 is disposed on the support platform 16′. However, the Hall-effect IC 16 can also be mounted on the circuit board 120 instead of on a slanted support platform 16′ in any position within range for detecting battery device 30 placement in position on the charging stand 10.

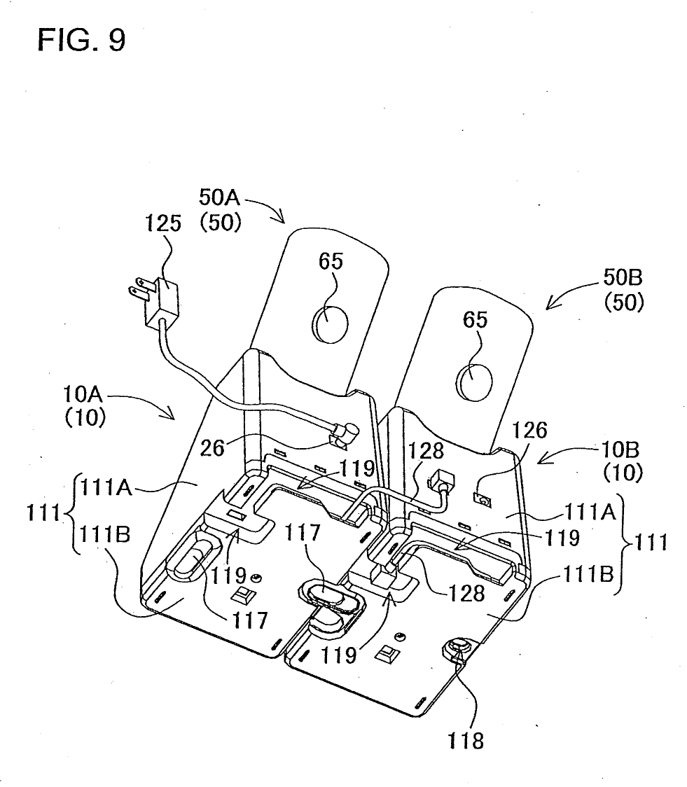

FIG. 9 shows a plurality of charging stands 10 arranged side-by-side to charge batteries housed in a plurality of battery devices 50. The charging stands 10 used in this arrangement are provided with connection sections 117 that allow connection of adjacent charging stands 10 in a detachable fashion. The connection section 117 is connected to the bottom of the lower casing 111B in a retractable fashion allowing it to rotate 90° in a horizontal plane. The connection section 117 is made of plastic. As shown in FIG. 6, the connection section 117 is provided with a pivot shaft 117a that projects upward at one end and connects with the lower casing 111B in a manner allowing rotation, and with a protrusion 117b that projects upward at the other end and mates with a cavity 118 in the lower casing 111B of an adjacent charging stand 10. The lower casing 111B is provided with a cavity 118 to mate with the protrusion 117b of the connection section 117 of an adjacent charging stand 10. When not in use, the connection section 117 is retracted and does not project outward toward an adjacent charging stand 10. When charging stands 10 are used side-by-side, the connection section 117 is rotated 90° out from its lower casing 111B, and the protrusion 117b is inserted into the cavity 118 in the lower casing 111B of an adjacent charging stand 10 to connect adjacent charging stands 10.

As shown in FIG. 9, power is supplied from an AC adapter 125 (corresponding to AC adapter 20 in FIGS. 1 and 3), which converts AC power from a commercial power outlet to DC, and inputs DC power to the power source connector 126. As shown in FIG. 9, the power source connector 126 is mounted in the rear of the casing 111. Further, a power source cord 128 is stored in an extendable fashion in the bottom of the casing 111 to supply power to an adjacent charging stand 10. A recessed region 119 is provided in the bottom of the casing 111 to store the power source cord 128. In the block diagrams of FIGS. 1 and 3, this power source cord 128 is connected to the output terminal 19. As shown by the arrow in FIG. 9, the jack at the end of the power source cord 128 inserts into the power source connector 126 to connect adjacent charging stands 10.

The charging stand 10 and battery charger 100 charge batteries 54 (corresponding to battery 40 in the block diagrams of FIGS. 1 and 3) in the battery device 50 with power from an AC adapter 125 or with power input to the power source connector 126 via the power source cord 128 from an adjacent charging stand 10. Specifically, the charging stand 10 transmitting coil 121 is magnetically activated.

As described above, a circuit configuration that sequentially charges batteries 54 in a plurality of battery devices 50 can fully charge those batteries 54 without increasing power input from an AC adaptor 125.

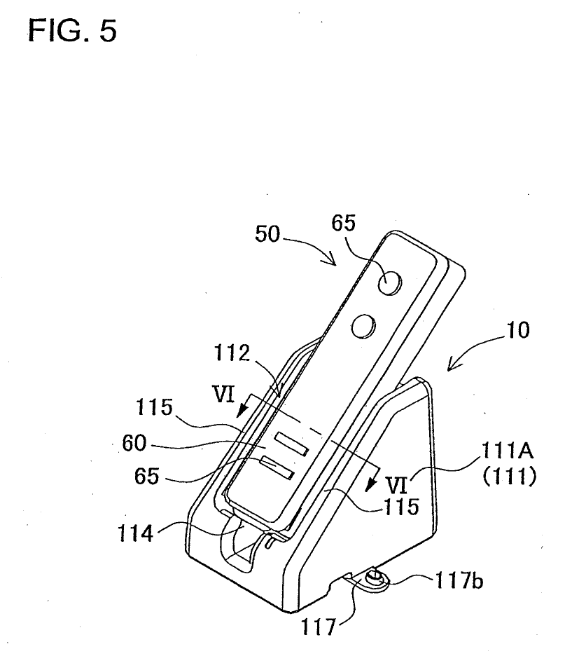

As shown in FIG. 6, the backside of the battery device 50 set in the charging stand 10 mounting section 112 is a curved rear surface 53 that conforms to the U-shaped curved bottom surface 113 of the mounting section 112. The receiving coil 51 is housed inside the curved rear surface 53 and is wound as a curved surface that conforms to the curved rear surface 53. The battery device 50 of the figures is provided with an operating section 65, which has controls such as switches, on the front surface and part of the rear surface. The battery device 50 is set on the mounting section 112 of the charging stand 10 to charge the batteries 54 inside. As shown in FIG. 5, the battery device 50 is set on the mounting section 112 of the charging stand 10 with the lengthwise direction of the battery device 50 inclined upward to the rear and the bottom end of the battery device 50 against the stopper wall 114.

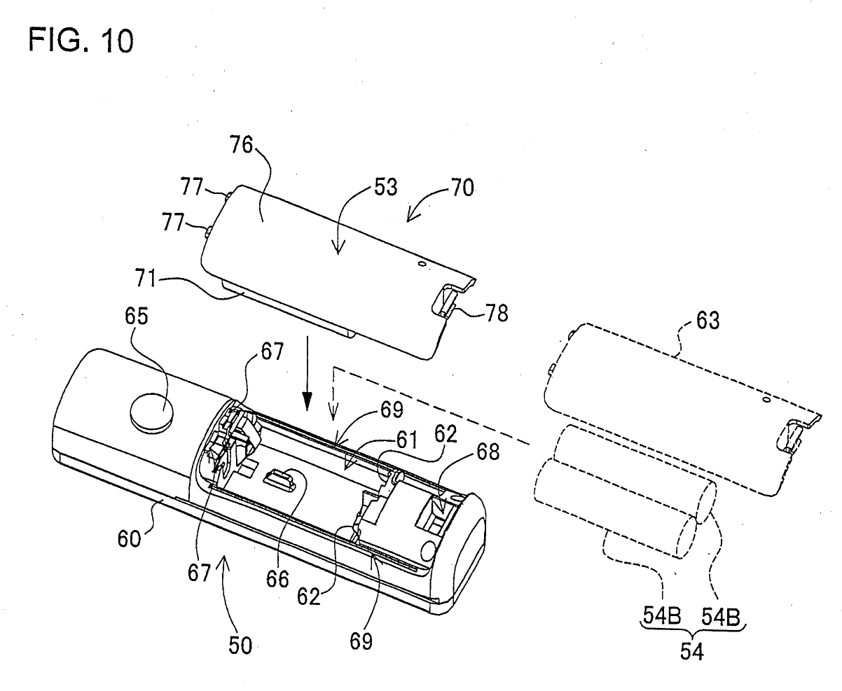

The battery device 50 houses the receiving coil 51 inside its curved rear surface 53, and the receiving coil 51 is wound as a curved surface that conforms to the curved rear surface 53. The battery device 50 shown in FIGS. 6 and 10 is made up of a device core 60 having a battery compartment 61 to store a plurality of circular cylindrical batteries 54 disposed in parallel orientation, and a battery pack 70 mounted in the battery compartment 61 of the device core 60 in a detachable fashion. An opening in the backside of the device core 60 establishes the battery compartment 61, and the battery pack 70 mounts in the battery compartment 61 to close that opening. In the battery device 50 of the figures, the battery pack 70 houses batteries 54 and the receiving coil 51, and the receiving coil 51 is disposed inside the curved rear surface 53. As shown by the broken lines in FIGS. 6 and 10, the battery compartment 61 of the device core 60 has a shape that allows a plurality of AA batteries 54B (two batteries in the figures) to be housed in parallel orientation. The battery pack 70 has a shape that allows it to attach in the battery compartment 61 in a detachable fashion instead of direct insertion of a plurality of AA batteries 54B (two batteries in the figures). As shown in FIG. 10, a battery device 50 with this structure can conveniently use either AA batteries 54B or a rechargeable battery pack 70. However, it should go without saying that instead of having a detachable battery pack, the battery device can also house a rechargeable battery in a non-detachable fashion, and dispose a receiving coil inside the curved rear surface to switch charging power to the battery. As shown by the broken lines in FIG. 10, when AA batteries 54B are loaded in the device core 60 battery compartment 61, the open region is closed off by a removable lid 63. The removable lid 63 connects to the open region of the battery compartment 61 in a removable fashion. AA batteries 54B are loaded in the battery compartment 61 with the removable lid 63 off. After loading the AA batteries 54B, the removable lid 63 is attached to the device core 60 to close off the open region of the battery compartment 61.

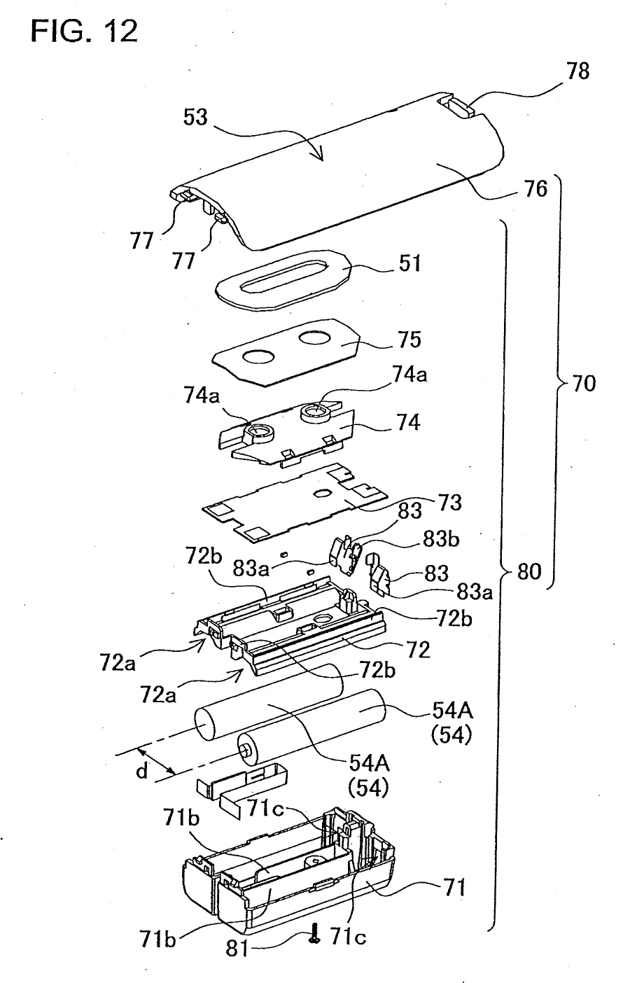

The battery pack 70 is mounted in the battery compartment 61 with the removable lid 63 off. The battery pack 70 mounted in the battery compartment 61 has a single-unit structure that integrates a removable lid. When the battery pack 70 is mounted in the battery compartment 61, the open region is closed off. The battery pack 70 is shown in FIGS. 11 and 12. FIG. 12 is an exploded oblique view of the battery pack 70 shown in FIG. 11. Further, FIG. 6 shows a cross-section view of the battery device 50 set in a charging stand 10. The battery pack 70 shown in the figures is provided with a battery casing 71 to hold the batteries 54, two AAA batteries 54A held in the battery casing 71, a battery holder 72 to retain the AAA batteries 54A in fixed positions, a circuit board 73 stacked on the battery holder 72 and connected to the batteries 54, a bracket 74 stacked on the circuit board 73, a shield layer 75 disposed on the bracket 74, a receiving coil 51 disposed on the shield layer 75, and a rear cover 76 disposed on the receiving coil 51. The rear cover 76, the bracket 74 and the battery holder 72 are formed from electrically insulating plastic. A magnet 37 is housed in an interior storage cavity of the rear cover 76

The rear cover 76 is formed as a curved surface that follows the curved rear surface 53 of the device core 60. Both the inner and outer surfaces of the rear cover 76 are curved surfaces. Since the rear cover 76 of the figures is used in place of the battery compartment 61 removable lid 63, the rear cover 76 has an outline that can close off the open region of the battery compartment 61. Specifically, the rear cover 76 is formed in the same shape as the removable lid 63. The battery pack 70 of the figures connects to the device core 60 battery compartment 61 via the rear cover 76. To allow attachment and removal from the open region of the battery compartment 61, the rear cover 76 is provided with locking hooks 77 integrally formed at its upper end (the lower left in FIG. 11), and a flexible hook 78 integrally formed at its lower end (the upper right in FIG. 11) that lock into the open region of the battery compartment 61. In this battery pack 70, the battery compartment 61 is provided with locking cavities 67, 68 at the upper and lower ends of the battery compartment 61 that accept the locking hooks 77 and the flexible hook 78 respectively. With the locking hooks 77 hooked into their locking cavities 67, the battery pack 70 is pushed into the battery compartment 61 to lock the flexible hook 78 into its locking cavity 68 and attach the battery pack 70 in a solidly fastened manner. The battery pack 70 can be removed from the device core 60 by resilient deformation of the flexible hook 78 to remove it from its locking cavity 68. Further, as shown in the cross-section of FIG. 6, the rear cover 76 is provided with ridges 79 at the center of its opposite edges that extend in the lengthwise direction. The ridges 79 interlock with guide grooves 69 provided at either side of the open region of the device core 60 battery compartment 61 to securely connect the rear cover 76 to the open region of the battery compartment 61.

The receiving coil 51 is made of metal coated with an insulating film, namely, copper wire, wound in a planar fashion as a flat coil. This flat receiving coil 51 is deformed to conform to the curved inner surface of the rear cover 76, and is disposed in close proximity to the curved surface of the rear cover 76. The receiving coil 51 is a long thin loop elongated in the lengthwise direction of the battery device 50, namely, in the lengthwise direction of the AAA batteries 54A, to enable efficient magnetic coupling with the transmitting coil 121.

The shield layer 75 is stacked below the receiving coil 51 to magnetically shield the circuit board 73 and batteries 54 from the transmitting coil 121. This shield layer 75 is a high magnetic permeability layer such as metal or ferrite that prevents any adverse effect on the circuit board 73 or batteries 54 from the high frequency power generated by the transmitting coil 121. The shield layer 75 is curved to conform to the shape of the receiving coil 51 and is disposed in close proximity to the rear surface of the receiving coil 51.

The bracket 74 is made of plastic and its surface facing the rear cover 76 is curved to conform to the curvature of the rear cover 76. A curved gap is established between the bracket 74 and the inner surface of the rear cover 76, and the shield layer 75 and receiving coil 51 are mounted inside that gap. The backside of the bracket 74 facing the circuit board 73 is made flat, or is formed with recessed regions to accept electronic components mounted on the circuit board 73, and the bracket 74 is attached stacked on the circuit board 73. In addition, the bracket 74 is provided with alignment projections 74a formed as a single piece with the bracket 74 for positioning the receiving coil 51. The alignment projections 74a insert into the hole in the elongated receiving coil 51 to align the receiving coil 51 in a fixed position. In the bracket 74 of FIG. 12, alignment projections 74a are provided at positions separated in the lengthwise direction at both ends of the elongated receiving coil 51 hole to dispose the receiving coil 51 in a fixed position. Further, the sections of the bracket 74 with alignment projections 74a are formed thicker to serve the dual purpose as shafts for screw attachment of the battery casing 71. The battery casing 71 can be attached to the bracket 74 by screwing set screws 81 that pass through the battery casing 71 into each bracket 74 alignment projection 74a.

A charging circuit for charging the batteries 54 is mounted on the circuit board 73. Circuits including the charging circuit 32, detection circuit 33, switching device 35, and interconnections shown in the block diagrams of FIGS. 1 and 3 are disposed on the circuit board 73. Electronic components 84 that implement the above circuitry including the charging circuit 32, detection circuit 33, and switching device 35 are mounted on the circuit board 73. The electronic components 84 are mounted on the bottom surface of the circuit board 73 in FIG. 12 (on the top surface in FIG. 6). Specifically, the electronic components 84 are mounted on the battery-side of the circuit board 73. The battery holder 72 retains a plurality of AM batteries 54A (two batteries in the figures) in fixed positions as well as disposing the circuit board 73 in a fixed position. The battery holder 72 is made of plastic and formed with battery 54 compartments 72a on the side facing the batteries 54. Since the battery pack 70 of the figures houses two AM batteries 54A, two parallel rows of compartments 72a are provided in shapes that follow the circular cylindrical contours of the AM batteries 54A. Here, battery pack 70 AM batteries 54A are loaded in the battery compartment 61 instead of the AA batteries 54B shown by the broken lines in FIG. 6. As shown in FIG. 6, since AM batteries 54A are smaller in diameter than AA batteries 54b, positions of the centers of AM batteries 54A are separated more than the positions of the centers of AA batteries 54B, and the gap between batteries is wider for AM batteries 54A. This gap between batteries establishes storage space 82 for disposing electronic components 84 mounted on the circuit board 73. Specifically, AM batteries 54A are separated as much as possible to maximize the storage space 82 between batteries. The battery holder 72 is provided with perimeter walls 72b formed as a single piece on the circuit board-side of the battery holder 72 to hold the circuit board 73 in a fixed position. The circuit board 73 is fitted inside the perimeter walls 72b to hold it in a fixed position. Further, the battery holder 72 has a recessed region 72c provided on the circuit board-side to accept electronic components 84 mounted on the circuit board 73. The recessed region 72c is between adjacent batteries 54, and electronic components 84 are disposed in the recessed region 72c to effectively use the storage space 82 established between batteries.

The battery casing 71 is formed from plastic in box-shape capable of holding a plurality of size AM batteries 54A (two batteries in the figures). The rear cover 76 attaches to the open region of the battery casing 71. Edges of the open region of the box-shaped battery casing 71 connect with the rear cover 76 in an interlocking fashion or are fused (welded) together to close off the open region with the rear cover 76 to complete assembly. The battery casing 71 shown in the cross-section of FIG. 6 has a groove 71a provided in its bottom surface that accepts a partition wall 66 provided in the battery compartment 61. The partition wall 66 is established between batteries 54 to hold AA batteries 54B in place. In addition, the battery casing 71 is provided with retention ribs 71b formed as a single piece with the battery casing 71 on opposite sides of the groove 71a, and the retention ribs 71b hold AM batteries 54A in place. AM batteries 54A are inserted between the retention ribs 71b and the side walls of the battery casing 71 to dispose the batteries 54A in fixed positions. Further, the battery casing 71 shown in FIGS. 11 and 12 has a contact windows 71c opened to expose output terminals 83. Battery power is delivered from the output terminals 83. The output terminals 83 shown in the figures are made by bending resiliently deformable sheet metal. Folded clips 83a, which fold to the inside of the battery casing 71, are flexibly pressed against electrode terminals at ends of the batteries 54 to make electrical connection. Further, the output terminal 83 on one side (on the lower side in FIG. 11) is provided with a flexible projection 83b, which is folded to the opposite side of the folded clips 83a, and projects out from the contact window 71c. The flexible projection 83b that projects out from the contact window 71 c is flexibly pressed against the power source terminal 62 provided in the battery compartment 61 to make electrical connection. As shown in FIG. 10, battery pack 70 output terminals 83 contact power source terminals 62 provided in the battery compartment 61 to supply electric power to the device core 60. The power source terminals 62 are disposed in locations that contact the electrode terminals of AA batteries 54B loaded in the battery compartment 61. Consequently, when a battery pack 70 is inserted instead of AA batteries 54B, electric power is supplied from the battery pack 70 to the device core 60.

The battery pack 70 described above is assembled by the following steps.
(1) Batteries 54 are loaded in the battery casing 71 and the battery holder 72 is disposed on top of the batteries 54 to hold the batteries 54 in fixed positions.
(2) The circuit board 73 and bracket 74 are stacked on the battery holder 72, the receiving coil 51 is stacked on the bracket 74 via the shield layer 75, and the receiving coil 51 is disposed in a fixed position on the bracket 74. In this configuration, the circuit board 73, batteries 54, and receiving coil 51 are interconnected, and the output terminals 83, which are connected to the circuit board 73, are disposed inside the contact windows 71c of the battery casing 71.
(3) Set screws 81 that pass through the battery casing 71 are screwed into bracket 74 alignment projections 74a to attach the bracket 74 to the battery casing 71 and form the battery assembly 80.
(4) The battery assembly 80 is secured to the rear cover 76 by attaching the rear cover 76 to the outer edges of the battery casing 71

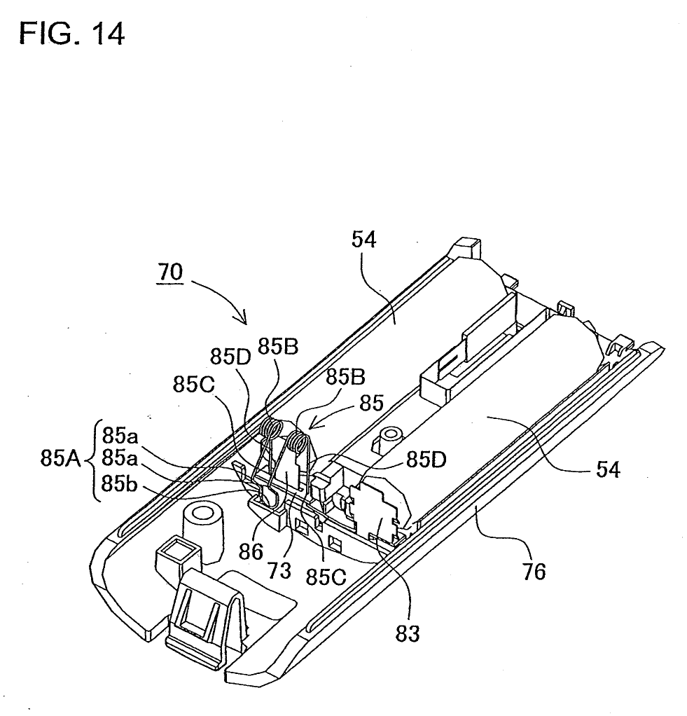

In addition, the battery pack can be configured with an output terminal as shown in FIGS. 13 and 14. In the battery pack 70 shown in these figures, the output terminal on one side (on the left side in the figures), which is the output terminal 85 having a contact region that projects out from the battery casing 71, is a spring contact formed from resilient metal wire. The output terminal 85 of the figures has a center section of metal wire bent in a rectangular shape to form spring arms 85A that project out from the battery casing 71, and both ends of the metal wire form attachment ends 85C that are fixed to the circuit board 73. Spring coils 85B are established symmetrically on the right and left sides between the spring arms 85A and the attachment ends 85C. These spring coils 85B serve as pivot points for rotation of the spring arms 85A, which establish a configuration where the spring arms 85A are spring-loaded to push outward from the battery casing 71. Further, the output terminal 85 is provided with standoffs 85D on both sides between the spring coils 85B and the attachment ends 85C, and these standoffs 85D dispose the spring coils 85B in positions away from the circuit board 73. Since an output terminal 85 with this structure has spring coils 85B provided on both sides of the spring arms 85A and has both attachment ends 85C fixed to the circuit board 73, contact pressure from the spring arms 85A can be doubled. By solder-attaching the attachment ends 85C to the circuit board 73 at two locations; this output terminal has the characteristic that it can be supported in a stable fashion while reducing contact resistance to the circuit board 73.

Further, contact regions 85a of the spring arms 85A that contact the power source terminal are bent out as protruding elbows. Since the spring arms 85A contact the power source terminal with two contact regions 85a bent as elbows, stable electrical connection can be made while reducing contact resistance. Further, the end region 85b of the spring arms 85A of the output terminal 85 is inserted into an insertion section 71d in the battery casing 71, and the end region 85b is restrained by an alignment wall 71e of the insertion section 71d to restrict the amount of contact region 85a protrusion. This structure maintains stable contact pressure while protecting the spring arms 85A.

As shown in FIG. 14, a lead plate 86 is spot welded to an electrode terminal at the end of the battery 54 on the side where the spring-contact output terminal 85 is disposed. The lead plate 86 is also solder attached to the circuit board 73. Further, the output terminal 85 attachment ends 85C are solder-attached to the circuit board 73 at both sides of the lead plate 86 to conserve space and allow stable assembly. Finally, the contact windows 71f that expose the spring arms 85A that protrude from the battery casing 71 can serve a dual purpose as retaining windows to hold the spring coils 85B. In this case, the contact windows 71f are formed as two windows sized to retain the output terminal 85 spring coils 85B. This structure has the characteristic that since the spring coils 85B are retained by battery casing 71 contact windows 71f, the output terminal 85 can be insulated while being held in a stable fashion without using any extra parts.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2008-186,571 filed in Japan on Jul. 17, 2008, the content of which is incorporated herein by reference.

What is claimed is:

1. A battery charger for charging a battery comprising:
a power supply circuit to supply charging power;
a control section to control the power supply circuit; and
an output terminal connected to the input-side of the power supply circuit via an input switch;
wherein when the battery becomes fully-charged, the control section controls the power supply circuit OFF and switches the input switch ON to redirect the input power out the output terminal.

2. The battery charger as cited in claim 1 wherein a power source connector is provided that connects with an AC adapter that converts commercial power to DC.

3. The battery charger as cited in claim 1 wherein the power supply circuit supplies power to charge the battery by a non-contact charging technique.

4. The battery charger as cited in claim 3 wherein the power supply circuit is provided with a transmitting coil that sends power to charge the battery.

5. The battery charger as cited in claim 2 wherein the power supply circuit is provided with a transmitting coil that sends power to charge the battery; and power input from the power source connector is converted to AC power and sent by the transmitting coil to charge the battery.

6. The battery charger as cited in claim 1 wherein a mounting section is provided where a battery device housing a battery can be set in a detachable fashion.

7. The battery charger as cited in claim 6 wherein the power supply circuit is provided with a transmitting coil that sends power to charge the battery; and the control section stops power transmission by the transmitting coil when a battery device charging error is detected.

8. The battery charger as cited in claim 6 wherein the control section stops power output when full-charge of a battery of a battery device set in the mounting section is detected.

9. The battery charger as cited in claim 4 wherein a current detection circuit is provided to detect current supplied to the power supply circuit; and the control section stops the supply of AC power to the transmitting coil when abnormal data is detected from the current detection circuit.

10. The battery charger as cited in claim 8 wherein a mounting section is provided where a battery device housing a battery can be set in a detachable fashion; the current detection circuit is a data receiving circuit that receives data transmitted from a battery device set in the mounting section; and the control section controls the power supply circuit according to data from the data receiving circuit, which is the current detection circuit.

11. The battery charger as cited in claim 6 wherein a Hall-effect IC is provided to detect a battery device set in the mounting section, and placement of the battery device in a specified position is detected by the Hall-effect IC.

12. The battery charger as cited in claim 11 wherein the control section controls the power supply circuit via signals from the Hall-effect IC.
